(19) United States
(12) Patent Application Publication
(10) Pub. No.: US 2011/0145043 A1
(43) Pub. Date: Jun. 16, 2011

(54) Method and System for Improving the Truthfulness, Reliability, and Segmentation of Opinion Research Panels

(76) Inventor: David Brian Handel, Galloway, NJ (US)

(21) Appl. No.: 12/637,806

(22) Filed: Dec. 15, 2009

(51) Int. Cl. G06Q 10/00; G06F 17/30

(52) U.S. Cl. 705/14.2; 707/822; 707/E17.009

(57) ABSTRACT

An example relates to survey analysis, survey panel members analysis, accuracy metrics, reliability analysis, and statistical analysis, to come up with confidence levels, and get an overall reliability of survey panel members, based on a score and percentile, and give incentives to the panel members, based on their reliability scores, to encourage them to be more reliable and truthful in the surveys, including their background and their demographics, increasing the values of the survey results drastically. In addition, this covers many separate embodiments: methods for improving and “incentivizing” truthful behavior in consumer panels; using Trustscore to measure and reward consistency and truthfulness; tag surveys to segment panels; and Doublecheck'd as a tool, to utilize the best responses through asking panel members twice (or more) with the same survey, and only including results from the members who answer the same both (or more) times.

### BACKGROUND OF THE INVENTION

There have always been major concern about the quality, reliability, truthfulness, and proper segmentation of the consumer panels and other collections of groups comprised of people being utilized for opinion research, in the prior art and in practice. In addition, the market analysis and reliability issues are major concerns for different industries, various persons and parties seeking to get correct feedback and taste analysis, to adjust the output and design of the factories and templates, for less inventory and more sales, higher values, or more profits.

In this invention, we have taught various methods to improve and enhance the truthfulness, reliability, and consistency of panel members and their responses to questions. We have taught improved techniques for segmentation of these panels and offering for purchase (monetizing) the process of segmentation. In this invention, we have taught various methods to improve this analysis and accuracy, for all business and marketing decisions, over any prior art, with incentives for the users to be more reliable and accurate, with monetary awards, increased prestige and points. In one embodiment, our software helps improving the research on people's opinions over a network, such as Internet. In one embodiment, we improve the quality of input information in terms of accuracy and honesty. In another embodiment we have taught a unique method of asking each respondent panel member the same survey twice on different sessions (“Doublecheck'd”) and only counting those responding towards the final results who have answered identically on both occasions, thus, dramatically improving the value of the collected data.

### SUMMARY OF THE INVENTION

This embodiment of the invention relates to survey analysis, user analysis, accuracy metrics, reliability analysis, and statistical analysis, to come up with confidence and get an overall reliability to analyze the survey, based on a score and percentile, and give incentives to the users, based on their reliability scores, to encourage them to be more reliable and truthful in the surveys, increasing the values of the surveys drastically, e.g. for marketing executives, or anybody interested in collecting opinions and a sampling of people's opinions or any subject for any reason, in general. In addition, in another embodiment, the inquirer of opinions sets and assigns tags to designate and choose/limit the scope or subset of the users, for himself/herself or others to use in the future, based on some monetary scheme which compensates the provider of the opinion research.

Different mathematical models are shown to analyze the data for this survey analysis, and define parameters such as confidence level or reliability, to quantify the results.

There is also a method for double-checking (for example, using variations, superset questions, trick questions, consistency questions, or same exact questions, later on) that improves the quality of the surveys, in terms of accuracy and honesty. Since consistency and truthfulness pays off for the respondents, the respondents are encouraged (e.g. have monetary and other incentives, e.g. points, lottery tickets, higher prestige, more opportunities for winning and more opportunities to answer additional surveys) in reward for being more candid and honest about their answers to questions and surveys, including their background and their demographics.

In one embodiment, it asks a set of questions (a survey) more than one time, to select respondents who answer that survey with the same answers both times and only adds responses to the survey outcome from those respondents who answer the same twice. In another embodiment, it also teaches an improved method of segmenting a group of people in a panel and a new method of monetizing that process.

### BRIEF DESCRIPTION OF THE DRAWINGS

FIG. 1 is a schematic diagram of the process of verifications for a user, as one embodiment.

FIG. 2 is a system for generating surveys, as one embodiment.

FIG. 3 is a system for generating and analyzing N questions, as one embodiment.

### DETAILED DESCRIPTION OF THE PREFERRED EMBODIMENTS

### TrustScore Embodiment

In one embodiment, we have an online market research business AskYourTargetMarket.com (AYTM), which is designed for small business owners, students, etc. (e.g. people seeking opinions of a population, for any reason). The survey charges, for example, X dollars for N respondents. It enables customers to define the target demographics for their respondents, and then it deploys a survey to that segment of the AYTM consumer panel that fits their defined target. We supply the consumer panel, too, for one embodiment.

In one embodiment, the AYTM consumer panel is located at InstantCashSweepstakes.com (ICS), a site that we have created and own. In one embodiment, the Surveys ordered at AYTM are sent over to the community at ICS to be answered. Members of ICS compete for prizes answering surveys, and most of the surveys they see are entertaining fun surveys. It is a unique feature that ICS asks a large and continuing quantity of fun and entertaining surveys of its panel members answers that enables ICS to continuously evaluate and reevaluate the individual ICS panel members for reliability, consistency, and honesty in their answers and declared demographics, and then use those measurements to give quantitative and qualitative feedback to panel members, in order to modify their behavior towards the kind of integrity which makes them valuable to AYTM's opinion research customers, when these same panel members are served opinion research surveys. The end result is increased value and credibility of the surveys for the marketing and business purposes, for marketing executives or product designers, for example.

In one embodiment, the ICS members supply their demographics as part of the ICS registration process, but they do not supply their name or exact home address. That way they feel more at ease to offer truthful demographics. Nonetheless, as a group, they are not 100% honest.

In one embodiment, the AYTM (Umongous, LLC) operates a second consumer panel site, PaidViewpoint.com (PV). PV has members who get paid for every market research survey question (Q) that they answer. We need to measure the trustworthiness of our consumer panel members and give them incentive to be more trustworthy. Members of the consumer panels (cp's) may be honest or dishonest in their declared demographics. Members of the cp's may fail to carefully read, or purposefully and thoughtfully answer market research survey Q's.

Therefore, one goal is to find a method for measuring online, on smart phone, or other electronic devices, a metrics for consumer panels for truthfulness, honesty, consistency, and reliability, and also, give them incentives (for panel members) toward optimal or truthful behaviors. Unlike other online consumer panels, ICS (and PV) asks many “fun and entertaining” questions of the panelists, when market research surveys are not being shown to a given member. A subset of those “fun and entertaining” questions will be used to test the honesty of the panel member in his or her declared personal demographics.

There is also a method for double-checking (for example, using variations, superset questions, trick questions, consistency questions, or same exact questions, later on) that improves the quality of the surveys, in terms of accuracy and honesty.

The panelists are purposely shown seemingly “fun and entertaining” Q's, mixed in with other actual “fun and entertaining” Q's, whose purpose is to specifically test the veracity of their declared demographics. For instance, in case of declared geographic location, such as a zip code in the Miami area, a question could be shown to that panelist asking, “Which NFL football teams are your friends and acquaintances most likely to root for?” Then, we include choices like Giants, Redskins, etc, along with the expected answer of “Dolphins”. A panelist who simply filled in any location during registration may not even remember their declared zip/county/state, and thus, may randomly choose an answer, or choose the wrong answer.

Of course, one question (and one wrong answer) is not enough to declare a person dishonest or inaccurate. We need many questions with hidden information checkpoints, so that we can statistically get to that conclusion with a good certainty. There is no 100 percent certainty, but we can get close to 95 percent certainty with a large number of checkpoints/verification questions/most-likely answers, for example 10-100 questions, depending on the certainty and specific question.

The more certain/specific question and answer, the fewer number of questions needed to get to 95 percent confidence level for overall conclusions, about the honesty or accuracy of the panelist.

The collection of the answers can be compared for many people, to get the degree (metrics) for the question/answer as how certain (C rating, for measuring non-ambiguous question) and specific (S rating, for measuring non-ambiguous answer) it is for that specific question and answer. For example, we assume a Gaussian or normal distribution, with most C ratings and S ratings are within 25 percent and 75 percent region, for all the people. Then, we normalize and assign ratings for all people and all answers for that specific question.

Let's assume that for question number 55, we get C rating of 88 percent and S rating of 92 percent, for person P, as one of the panelists. That means that confidence level overall (L) for that person is around 90 percent (very high), and close to 95 percent (our goal, for example). Thus, we need only 10 (N) questions in that level of C ratings and S ratings, to get to 95 percent or higher certainty, overall, to evaluate the honesty of the panelist P.

Let's assume, as an example, for demonstration purposes, that (to get to 95 percent overall confidence) we need, at the minimum, the following:
for L=90 percent or 0.90, we need N=10 questions
for L=50 percent or 0.50, we need N=50 questions
for L=30 percent or 0.30, we need N=100 questions

Mathematically, we can model that as follows:

L=((S+C)/2), Equation 1

wherein L is expressed in percentage.

N=proportional to (1/L), or

N=proportional to non-linear version of (1/L), Equation 2

wherein N is a unit-less positive integer.

For example, Eq. 2 can become:

N=A+Round(B/L) Equation 3

wherein the function “Round” rounds the generally real number (B/L) to the nearest integer. A is also a positive integer.

For example, specifically, for B=1.00:

N=A+Round(1.00/L)

### or, for L=0.90:

N=A+Round(1.00/0.90)=A+1

### or, for A=9:

N=9+1=10 Equation 4

(to fit one of the desired experimental points above, as an example, in the example above)

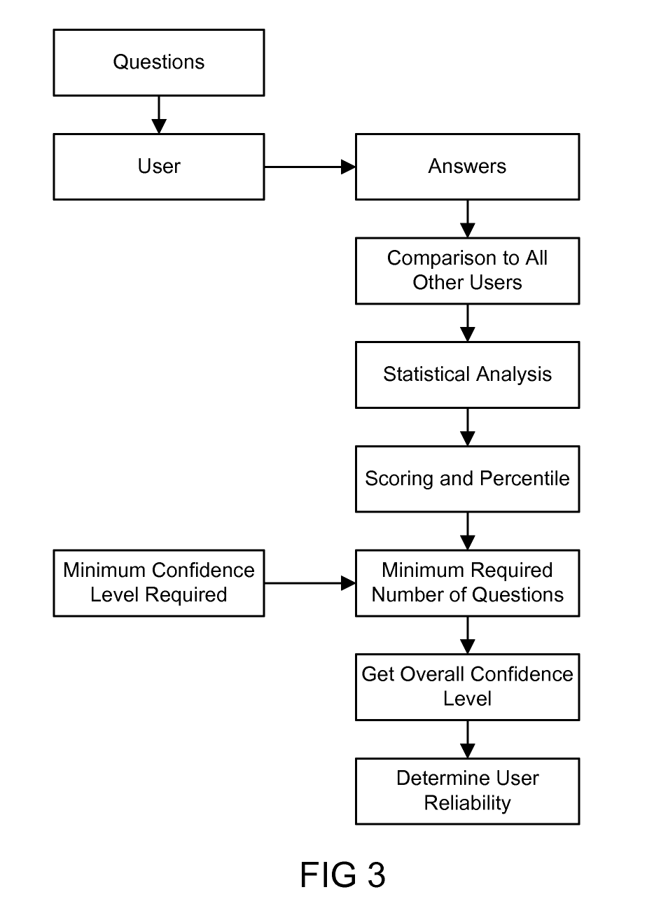

Of course, other parameters and coefficients can be used to model differently, or match a specific numerical or experimental table or curve. FIG. 3 is a system for generating and analyzing N questions.

Of course, this is just an example, and any other similar linear or non-linear relationships will also work here, such as, giving more weight to value of C, relative to S, in which Eq. 1 becomes as follows, as an example:

L=((S+2C)/3), Equation 5

Of course, any mixture of the L values for different questions is possible, which requires more or less N, depending on the way it goes. For example, if the questions tend to be less L value in the future, we may need higher N value to compensate for that, and vice versa.

The questions that are certain could for instance be related to neighborhoods in a specific region, which can be extracted automatically from a site such as Google maps, or with a contract with that site, or with a search engine, such as Google engine. Examples are names of streets, new local expansion of metro, new widening of local roads, new construction projects, new owner of the local football team, new coach of a local university, local temperature, local weather, local anchor person on local TV, local radios, local hero, local news, local mayor, local congressman or woman, and similar information, which can be stored on big databases for each locality, and updated frequently, to increase the values of C ratings and S ratings, and thus, the overall confidence level.

Our company (practicing this technology, as an example) can maintain such databases, as a service, for higher accuracy, and gets compensated/paid for the results of survey by the companies, individuals, or entities, interested in that specific survey or locality/demographics, or interested in that specific survey of respondents and panelists processing specific demographic parameters.

One of the things we also use to test is the geo-location of panelists against the location expected or predicted by their IP addresses. While this is technique is very flawed, it is a test of other information. The reason why we mention it here is that we can include the football team closest to the city that their IP address suggests they are from, as an answer choice in the just mentioned Q, and trick them into a being exposed by a lie, if their IP address and declared location in their demographics are not congruent.

For the age, career, or location verification, the slang, interests, or common experiences/preferences used (or common/familiar) by the people in different age or other demographic groups, or different words or spellings associated with a background/job or location, can be used in combination, to increase the accuracy and confidence.

For example, we could test their declared household income with Q's about activities which they and their friends/acquaintances should be interested or capable of affording, to participate in, based upon their income brackets. For instance, someone with an income under $25,000 would be unlikely to drive a Lexus, have a membership in a private country club, or buy a three-karat diamond engagement ring.

While no single Q can give a conclusive impression if the panelist is being truthful about their demographics, a large series of Q's can allow us to make reasonable assumptions.

Those “fun and entertaining” questions can be used to test the truthfulness, honesty, consistency and reliability of the panelists, so that they can then be given incentives towards optimal behaviors, which hopefully will be applied when they answer any Q, whether in a market research survey or in fun survey.

For instance, repeating previously answered fun Q's on a subsequent session to see if the panelist chooses the same answer tests for consistency and reliability. Asking in one session if they own a dog, and then in a subsequent session, asking those who said yes, “do you own a pet?” tests for consistency, truthfulness and honesty, as an example.

How we give incentives, as an example: We pay our users at PV on a per-question-answered-basis. We pay panelists more per market research Q answered, as their TrustScore (TS) rises. We can also provide lottery tickets, opportunities to answer more surveys, and therefore have more opportunities to win prizes, and other incentives to ICS members, with bonus tickets given relative to how high their TS is, as an example, or in combination with other methods here.

In one embodiment, we have chosen to make the TS relative, by using a percentile scale. That way, panel members must continuously compete to maintain their TS or risk slipping behind, as others raise their own TS's. TrustScores are mostly determined by the techniques described above, based upon the results of their answers to “fun Qs”. Answers that are congruent, consistent, and reproducible (by showing the same Q on different sessions, or asking for the same data point with different wording or question) add points to their raw TS. Answers that are not congruent, consistent, or reproducible cause points to be subtracted from their raw TS, as adjusted TS.

Then, all of the panelists are assigned a percentile rank based upon their raw TS. The percentile rank is what we show the panelists, not the raw score (in one embodiment). We explain the basic tenets of the TS system and tell the panel that we do not know their exact identity (in one embodiment). Therefore, it is in their best interest to be as honest and candid as possible in both their declared demographics and their answers to all fun Q's and market research Q's (in one embodiment).

We explain that we evaluate all answers and data they supply and look for evidence of honesty, believability, credibility, consistency, etc. (in one embodiment). We tell them that the more we trust them, the higher their TS. We tell them that the score that they see is a percentile, and that even if they do nothing to actively change their score, it can rise or fall depending on how other panelists are doing. We tell them that the best way they can raise their TS is to be honest in their demographics and to answer many fun Q's honestly and consistently (in one embodiment). (“The truth is easier to remember than a lie.”)

Panelists are therefore given strong incentives to answer many fun Q's in an effort to raise the amount they are paid for every market research Q they answer (in one embodiment).

Additional techniques we utilize to evaluate the truthfulness of a panelist's declared demographics (in one embodiment): When people join our panel and go through the registration process, we compare their predicted location based upon the IP address. If theirs are inconsistent, they lose raw TS points, but if they are consistent, they are given points (in one embodiment). We ask registrants to enter their State, county and zip code. Then, we check against a DB (database), and we add/subtract TS points based upon concordance of the information.

We look at entered demographics for patterns of believability/unbelievability (in one embodiment). For instance, for the demographics submitted as: a single person, who is unemployed, but claims to have $200K income, would lose TS points for this pattern of demographics. Even though some patterns might be the actual truth in individual cases, we feel that in the long run, or average, taking away points for unlikely patterns helps properly grade most people, overall, for many cases, statistically (in one embodiment).

We offer opportunities for registrants to gain extra TS raw points by optionally supplying their cell phone number and participating in an SMS validation code step. We also check their cell's area code vs. their declared geo-location. We offer opportunities for registrants to gain extra TS raw points by optionally allowing GPS verification if they have a GPS capable phone (or GPS-capable browsers on Internet or on any gadget or device) (in one embodiment).

We also, in one embodiment, tag each panelist's computer or other device with a cookie in order to prevent multiple accounts from operating from that device and this helps limit each member to a single account.

Because panel members answer so many fun and entertaining questions, we are able to build up a progressively unique digital fingerprint of each member. This is useful because should that panelist try to set up alternate account on a different device, the TrustScore system will encourage them to maintain their true and consistent persona, since it is easier to remember the truth. Thus, their digital fingerprint will emerge in the second account, reveal that it is a duplicate, and unmask that they are cheating the system by operating a duplicate account.

Eventually, members who earn $600 or more will have their cash out capability temporarily frozen, until they supply their name/address/SSN, so that we can send them a 1099-misc, for tax purposes, for IRS, federal tax requirements (in one embodiment). This is the first time that we know their true identity. But, by the time we tell them we need this information, we know their demographics, and they have had a good experience with us (and they have learned to trust us). We are simply complying with the law by asking for the information needed to issue a 1099 form. We will give TS points in exchange for getting this information (in one embodiment). This example is for US tax purposes, but in general, can be applied to any tax or government-mandated filings and forms, for tax or business purposes, or any other declarations for other purposes. Despite gaining their true identity for the purpose of filing their 1099, we maintain their privacy in all other respects.

We look at the speed that members answer Q's and if way too fast we subtract points because they are either an insincere human or a bot, as a possibility (in one embodiment). We use a series of techniques for eliminating the chance that an account is really a bot, and we prevent such accounts from answering market research Q's or making money (in one embodiment). Multiple accounts from the same IP address always being operated one after the other in patterns suggests that it is from the same user. We also leave a cookie on each participating computer or electronic device, in order to track behavior and usage of the accounts, as one embodiment. However, more accounts could be explained by a group of family members, as a legitimate user(s).

Other red flags are: failure with CAPTCHAs, unusually fast activity during a session (felt to be bot behavior), or if that account always shows same speed (it is declared to be a bot, and then, it is given a series of CAPCHA Q's to confirm).

Additional ways to manage the TrustScore: We watch patterns of answering by respondents and take away TrustScore points when users do things like repeat certain patterns regularly, such as answering by choosing answer #1 for each Q over and over, or answer A1 for Q1, A2 for Q2, A3 for Q3, etc. (in one embodiment) (or other repeated answer patterns).

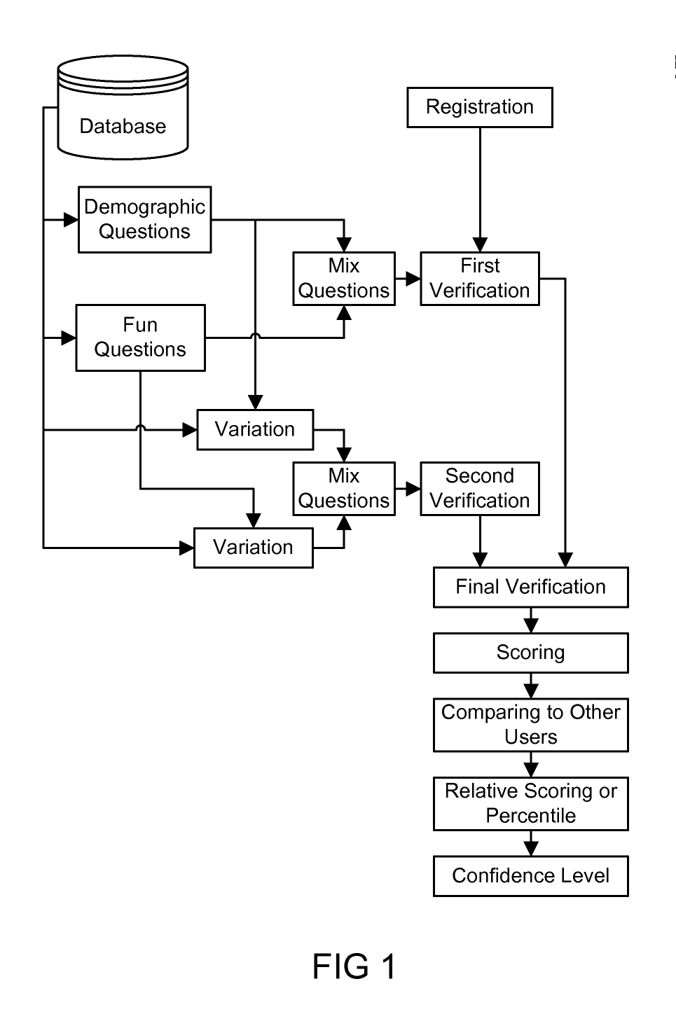

FIG. 1 is a schematic diagram of the process of verifications for a user.

We offer customers at AYTM for even more enhanced confidence, the opportunity at an extra fee, to send a “DoubleCheck'd” survey. With this, we send the survey to their chosen demographic group and resend it to all first pass respondents on a second session at ICS at least 3 hours after the first session (in one embodiment). The respondents do not know in advance that this particular survey will be repeated. We only count as respondents for the survey those who answer it both times the same exact way. This further reduces the chance that a respondent thoughtlessly answered the survey, or be dishonest on the survey. In general, in one embodiment at ICS, fun and entertaining surveys are occasionally repeated, and triple prize awards are given, if the members answer the survey the same as they did the last time. We congratulate them when they succeed and explain how they earned the triple prize. If they fail to repeat the same set of answers we tell them that they missed an opportunity to triple their prize. In this manner, we have used behavior modification to condition them to answer all surveys carefully with their sincere opinions, since those are the opinions they can most easily remember and repeat. This training prepares them to answer opinion and market research surveys with the same candor.

Another embodiment is Tag Surveys. Most consumer panels ask their members a series of Q's that they can be segmented for targeting. ICS/PV asks a basic series of Q's addressing fundamental demographics, such as gender, age, income education, race, relationship status, work status, chosen career, etc. Some other panels claim that they know 400 or more data points about their panelists (in one embodiment). Presumably they achieve this by having panelists answer a large online form at registration, or they send out a prescreening short survey to their panel, as needed, for a special order, but only get responses from a small portion of the panelists, as two examples of a technique to implement.

ICS/PV uses seemingly “fun Q's” to tag the panelists over time with an unlimited number of data points. Purchasers can order a “tag survey”. In one embodiment, they can order a tag survey that asks a single question, with a binary answer selection such as True/False, Yes/No, etc. It is delivered to the entire consumer panel. Therefore, for entire panel, something that appears to be a fun question, will be tagged as positive or negative for this trait (or narrowing the segment of the consumer panel to members who are either positive or negative for a particular tag). For instance, if we have served the tag Q to members “Do you own a dog? answer: Y|N”, then you could send a survey to a particular demographic group (say, a certain gender and income range, for instance), and further select a subset of those people who either do or do not own a dog (in one embodiment). Because the entire ICS and PV panel answers all fun survey questions which are pushed to the top of their queue, any tag survey will be answered by 100% of the active panels, rather than the small response and success rate seen by traditional approaches, which do not utilize a continuous flow of fun questions tied to incentives.

Tag Q's answers are always binary (in one embodiment). The answer is either Y|N, T|F, etc. (Yes/No or True/False). The concept of continuous gathering of data points on the panel through tag Q's opens up the possibility of giving the customers at AYTM the ability to create paid tag Q's. This type of survey is a one Q survey with a binary answer (in one embodiment).

It could be more than a single Q, but for one embodiment, we implement it with a single Q. AYTM customers would be charged to launch a tag survey. They would receive a report (in one example) with perhaps how the first 1000 respondents answered, and the demographics of those respondents, so they could analyze the answers vs. the demographics. For instance, you might ask “Do you own a Mac? with answer: Y|N”, and then find out that 12% say Y, 61% of the 12% are females, 3% of the 12% are Asian American, with household incomes between $75-100K, etc. But, even though we might supply the purchaser of the tag Q survey with the results of the first 1000 respondents, we would push the tag Q to the entire population of the panel, and therefore, get everyone tagged for “Do you own a Mac? Y|N” question/criteria/property.

We could either automatically parse the tag Q to write the final tag text used to identify the respondents based on their answer, or we may do this step manually, or by crowd-sourcing, perhaps by using an existing service such as www.crowdflower.com or Mechanical Turk, as an example.

For instance, in one embodiment, “Do you own a Mac? Y|N” respondents would be tagged as either positive or negative (e.g. either “Mac owner” or “Mac doesn't own”). The purpose of well-written tags is to allow them to be easily searched in an auto-fill search text entry box (a la Google text entry search field) on the AYTM (“define your target market” page). Thus, all of the Mac-related tags should begin with the word “Mac”, as an example, for simplicity and ease of operation, in one embodiment.

Once the panel has been tagged for a custom tag written by an AYTM customer, that tag could be “open-sourced” (as an example) and placed in the publicly available tag database, searchable in the auto-fill search box, just mentioned above. Now, the purchaser of the custom tag can come back and create a full survey, to send to a segment of the ICS/PV panels, who are either positive or negative for said tag. This is very powerful because it allows anyone to segment the panel for a characteristic that interests them, and then come back and send their segment a market research survey. For instance, if you wish to survey people who use Autodesk products, you could first tag the panel for this, and then come back and write a survey for those who use Autodesk products to answer. You could further narrow the target group by additional demographics or even additional tags, although we offer that possibility only when we have a huge panel (in one embodiment).

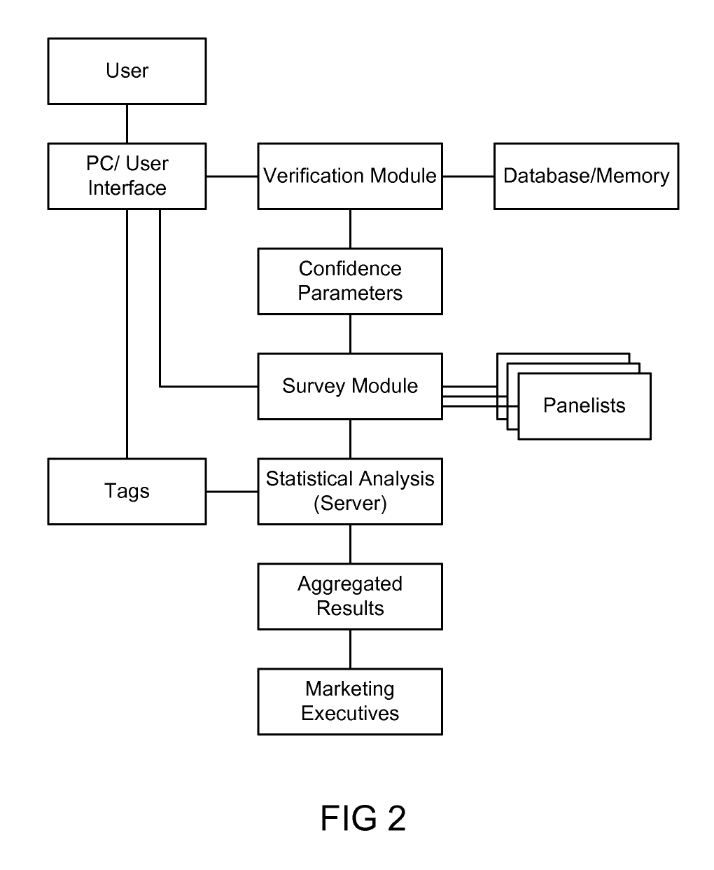

We expect to give the original purchaser of the tag unlimited free future usage of their tag, without raising the price of their surveys, beyond what they are otherwise charged for their future surveys (since they previously paid to tag the panel). Everyone else will pay extra to use that tag to narrow their target market (in one embodiment). Therefore, the subject of this process is a method for tagging members of a market/opinion research consumer panel for various traits, permitting third parties to purchase the creation of such tags, and then permitting all third parties to select panel members with certain desired tagged traits, as the basis or partial basis for selection into a market research sub-panel, which can then be sent specific online/on smart phone (or other electronic device) market research surveys. FIG. 2 is a system for generating surveys.

In one embodiment, one can buy surveys or credits to design or take a survey, using a table, with payment history shown, as an example. In one embodiment, regular surveys are 3-5-question long. Branched logic or skip logic surveys add the additional feature that you can specify a unique question to be asked, dependent upon the current chosen answer. Thus, for a 3-question survey, one can write as many as 31 questions and have a custom question assigned to follow each answer, as an example. For example, after question 1, its 5 answers could lead to 5 different question number 2s. In turn, these 5 different question number 2s could lead to (5×5) (or 25) different question number 3s.

For Target, in one embodiment, we have the following options: education, gender, age range (shown on a linear scale on screen), income, race, education, employment status, career, relationship status (single, married, . . . ), location (city, state, . . . ), DoubleCheck'd, number of responses, and similar parameters, as an example.

In one embodiment, we have fulfillment meter. In one embodiment, we have filters, such as gender, such as male/female. In one embodiment, on menu/screen, we have “define target market”, connected to “write survey”, connected to “pay/launch”, which gets the results fast. In one embodiment, we have Dashboard, with table, with the following parameters, shown on screen for the user: title, price, modified date, target, edit, preview, launch, and clone. In one embodiment, we have “Regular survey” and “Branched logic survey”, as shown in the menu, as choices, for the user, in screen/monitor of the computer, or user interface (GUI).

In one example, the question originally asks about if a user has a dog, and for the second time, asks about if a user has a pet. Since dog is a subset of pet, it can verify the first question for us, in variation form, to disguise, for the user. The table of equivalent questions or terms/objects/languages/words/concepts (e.g. dog and pet), or a relational database (relating dog and pet, or set/subset), can be used to generate new or equivalent/disguised questions from the original questions, automatically, based on the structure of the question/sentence.

For example, for the question “Do you have a dog?”, we will have “Do you have a X?”, and in the database, we have a relationship between X and Y, which is defined as Y=“pet”. Thus, we replace X with Y, or “pet”, which will become: “Do you have a Y?” or “Do you have a pet?”, which is a simple substitution, based on the template of the question, whose structure and format are predefined. This way, one can measure the honesty and consistency of the respondents.

“Fun” questions can be unrelated questions, which usually do not have any demographic purpose or intention. Rather, they are for fun, and try to entertain the user, and also make it harder for the user to guess which ones are serious questions about demographic information, and which ones are not serious (fun category). For example, it may ask about sports in general (e.g. “What is the fastest serve in tennis, so far?”), with no attempt to ask specific questions about the local teams, as an example, which can verify the demographic.

In one embodiment, a method of survey panel member verification comprises supplying a question and with corresponding answer. Then, the member receives the question, and answers the question, which is compared to the right answer, to determine a reliability of the response. Then, the response reliability is normalized and scored, on a scale, to produce a score, which is shown to the member, with explanations and rules, which determines the amount of incentives to the member, e.g. based on the score.

In addition, this covers many separate embodiments: methods for improving and incentivizing truthful behavior in consumer panels; using Trustscore to measure, incentivize, and reward consistency and truthfulness; tag surveys to segment panels; and Doublecheck'd as a tool, to utilize the best responses through asking panel members twice (or more) with the same survey, and only including results from the members who answer the same both (or multiple times), as described above. In one embodiment, all times, the answer must be the same, and in another embodiment, majority (e.g. 51 percent) or super-majority (e.g. 75 percent) of the answers must be the same (or consistent).

In one embodiment, the person or entity seeks opinions of a group sets and assigns tags to designate and choose/limit the scope or subset of the panel members. There is also a method for double-checking (for example, using variations, superset questions, trick questions, consistency questions, or same exact questions, later on) that improves the quality of the surveys, in terms of measuring and rewarding accuracy and honesty. Since consistency and truthfulness pays off for the panel members, the panel members are encouraged (e.g. have monetary and other incentives) to be more candid and honest about their answers to questions and surveys.

All of calculations are done on a PC, computer, server, PDA, processor, microprocessor, or similar device, with all the data, results, comparisons, or questions/answers are stored in a database, table, list, relational database, RAM, ROM, CD-ROM, hard drive, magnetic or optical storages, or memory/ storages, with all the users or administrators (at every stage or capacity) interfacing through GUI or UI/user interface, mouse, keyboard, tablet, monitor, touch-monitor, or stylus. The data is collected form panelists over a network, Internet, World Wide Web, Cellular, wireless, digital, or any other computer or telecommunication network.

Any variations of the above teaching are also intended to be covered by this patent application.

1. A method of survey panel member verification, said method comprising:
supplying a first question and with corresponding a first answer;
a member receiving said first question;
said member answering said first question with a first response;
comparing said first response to said first answer to determine a reliability of said first response;
normalizing and scoring said reliability of said first response on a scale, to produce a score;
showing said score to said member; and
giving incentive to said member, based on said score.

2. The method as recited in claim 1, said method further comprising:
determining a number of questions needed to get over a threshold for a confidence level; and
supplying said number of questions needed to get over said threshold for said confidence level.

3. The method as recited in claim 1, said method further comprising:
determining an overall reliability of all answers by said member.

4. The method as recited in claim 1, said method further comprising:
asking different variation of said first question from said member.

5. The method as recited in claim 1, said method further comprising:
comparing different answers for different questions.

6. The method as recited in claim 1, said method further comprising:
mixing into fun questions an indirect and inferential demographic verification-type challenge or question.

7. The method as recited in claim 1, said method further comprising:
giving relative scoring and percentile to said first response or said member.

8. The method as recited in claim 1, said method further comprising:
using a database to store questions and corresponding answers.

9. The method as recited in claim 1, said method further comprising:
using a database to store variation of questions and corresponding answers.

10. The method as recited in claim 1, said method further comprising:
analyzing statistical data.

11. The method as recited in claim 1, said method further comprising:
aggregating all answers and confidence levels

12. The method as recited in claim 1, said method further comprising:
changing order of questions in a second set of questions, compared to a first set of questions.

13. The method as recited in claim 1, said method further comprising:
changing format or language of questions in a second set of questions, compared to a first set of questions.

14. The method as recited in claim 1, said method further comprising:
adding a tag to a survey.

15. The method as recited in claim 1, said method further comprising:
limiting a set of said members.

16. The method as recited in claim 1, said method further comprising:
using one or more of following parameters for verification process: age, sex, address, marital status, career, income, hobbies, pets, sports, favorite people, or favorite objects.

17. The method as recited in claim 1, said method further comprising:
giving incentives, credits, points, gifts, awards, or cash, to said member, based on credibility score of said member.

18. The method as recited in claim 1, said method further comprising:
dynamically changing credibility score of said member, relative to others.

19. The method as recited in claim 1, said method further comprising:
reducing or increasing credibility score of said member, based on predetermined triggering events and conditions.

20. The method as recited in claim 1, said method further comprising:
assigning different future question based on a previous answer.
